(19) United States
(12) Patent Application Publication
(10) Pub. No.: US 2012/0097137 A1
(43) Pub. Date: Apr. 26, 2012

(54) GAS-DYNAMIC PRESSURE WAVE MACHINE

(75) Inventors: Georg Glitz, Paderborn (DE); Christian Smatloch, Paderborn (DE); Urs Wenger, Rumisberg (CH)

(73) Assignee: Benteler Automobiltechnik GmbH, Paderborn (DE)

(21) Appl. No.: 13/379,529

(22) PCT Filed: Sep. 13, 2010
(86) PCT No.: PCT/DE10/01070

§ 371 Date: Dec. 20, 2011

(30) Foreign Application Priority Data
Sep. 15, 2009 (DE) 10 2009 041 123.2

(51) Int. Cl. F02B 33/42; F04F 13/00

(52) U.S. Cl. 123/559.2; 417/64

(57) ABSTRACT

A gas-dynamic pressure wave machine for a combustion engines includes a crankcase ventilation system (11). The crankcase ventilation system (11) is connected to a cold gas housing of the pressure wave machine (3) and leads in particular into a cold gas side of the control disk of the pressure wave machine.

The invention relates to a gas dynamic pressure wave machine with the features set forth in the preamble of patent claim 1.

The mutual alignment of the openings of the high pressure ducts, i.e. the high pressure exhaust ducts and the high-pressure charge air duct, is an important regulation variable of gas dynamic pressure wave machines. With regard to the regulation of this alignment, it is known from DE 69823039 T2 to rotate the cold air housing, e.g. by a servomotor or pneumatic, mechanical or hydraulic means. For this purpose, each point of the performance field of the combustion engine is calculated and converted by an electronic control system into appropriate control commands for the rotation of the housing.

This type of regulation of the control edge shift is disadvantageous because the rotation of the cold gas housing, including the lines attached to the housing, requires very flexible lines and a need for large installation space. In addition, considerable forces must be applied by the necessary actuators. As a result of the fact that relatively large masses have to be moved, the adjustment system has an unavoidable inertia. Previous solutions are lagging behind the requested operating state of the engine during regulation, and are realized with high complexity of the structural parts.

The state of the art further includes DE-B-10 52 626 and DE-A-30 40 648. These publications disclose the use of plates or rings that are provided with openings and attached at the inlet of the high pressure ducts. The plates or rings are mounted on the respective housings to influence the alignment of the openings of the high pressure ducts. In this variant, the masses that have to be moved are smaller. However, gap losses that are caused between the control disk and the rotating cell rotor are problematic.

An aspect that by no means is negligible in combustion engines is the so called engine ventilation. Every combustion engine generates combustion gases which do not exclusively enter the exhaust but can also bypass the piston and reach the crankcase as a result of the high pressures. If these gases were not diverted from the crankcase, the pressure in the crankcase would rise intensely, with the consequence that the pistons would have to work against this pressure in the crankcase.

For reasons of environmental protection, the oil—contaminated gases are not released into the environment. Also, it would be unfavorable to feed the gases into the exhaust system, since the oil mists would lead to damage to a catalytic exhaust-gas converter, which in turn would have a negative effect on required exhaust limit values. Therefore, the gases are fed into the intake duct.

The pressure conditions in the intake duct therefore have an impact on the ventilation of the crankcase. Since the gases are carried along by the general airflow in the intake duct, the ventilation of the crankcase cannot be influenced independently.

In light of the foregoing, the invention is based on the object to provide a gas dynamic pressure wave machine, with which the engine ventilation can be improved.

This object is solved by the pressure wave machine according to the invention by connecting the crankcase ventilation to a cold gas housing of the pressure wave machine. In view of the direct connection of the crankcase ventilation on the cold housing of the pressure wave machine, connection points in other areas can be saved without significantly increasing the complexity of the already machined cold gas housing of the pressure wave machine. Overall, a cost advantage is attained, particularly when the cold gas housing is provided with a control disk. Such a control disk at the end of the cell rotor has openings, with the position of the openings in relation to the openings of the hot gas housing openings being variable. Such a control disk can have an opening to connect an intake zone of the cell rotor to a line of the engine ventilation assigned to the opening.

A separate engine ventilation duct, which is assigned to a control disk opening provided specifically for this purpose, results in a separation of the general intake airflow from the gases of the engine ventilation duct. This allows to influence the engine ventilation much more precisely than in cases where the engine ventilation duct feeds into the general intake duct. The complete mixture of the intake air with the ventilation gases occurs only when the respective gases flow into the cell rotor, i.e. in the low pressure range.

The engine ventilation is configured in such a way that the low pressure conditions in the ventilation duct are suited to the requirements of the respective engine.

The opening in the control disk provided specifically for the engine ventilation is, of course, dimensioned to ensure engine ventilation, even when the control disk is rotated. Through rotation of the control disk, the opening cross section of the intake openings of the pressure wave machine can be changed and the engine ventilation can thus be influenced. In any event, the opening of the engine ventilation remains permeable for gases that have to be discharged from the crankcase.

To further decouple the pressure conditions of the crankcase ventilation and the gases in the intake zone, the line of the crankcase ventilation that leads to the pressure wave machine can have a throttle. A check valve may also be integrated into the line so that gas is exclusively aspirated via the crankcase ventilation but cannot flow back to the combustion engine via the crankcase ventilation.

According to an advantageous refinement, the opening that is provided in the control disk of the pressure wave machine is oriented in such a way as to extend in a radial direction with regard to the longitudinal axis of the control disk and the cell rotor, respectively. That means that the control disk does not only have openings that allow an axial feed of cold gas but also openings that allow a radial feed of the crankcase gas.

According to an advantageous refinement, a compensating chamber is arranged in the cold gas housing. for attachment of the lines of the crankcase ventilation and communication with an intake zone of the cell rotor via the opening in the control disk. Using the compensating chamber enables compensation of certain pressure fluctuations. In addition, the compensating chamber assumes the function that the opening remains permeable to gas even when the control disk is rotated relative to the cold gas housing. Consequently, given an appropriately large compensating chamber which extends in the circumferential direction of the control disk, the opening is coupled with the intake zones of the gas dynamic pressure wave machine at all times.

In general, the advantage of using control disks is that no movable parts are present in the engine compartment such as for example tubes that are connected to an overall adjustable housing. As a result, it is possible to simplify the line connections to the pressure wave machine. In addition, the mass of the moving parts is greatly reduced so that the actuators are less subject to stress. Compared to partly rotatable housings, the installation space of the pressure wave machine according to the invention is smaller. This allows for a more compact design.

A further advantage is that the control disk can also be used as tolerance compensation for the gap between a cold gas housing or hot gas housing and the cell rotor. An elaborate sealing at the transition between a rotor housing and a cold gas housing as it is needed in rotatable housings is eliminated completely.

Finally, mechanical assemblies for the regulation of the position of the control disk can be reduced to a minimum. Because of the smaller actuating forces, use of a smaller electrically powered actuator is sufficient.

Exemplary embodiments of the invention will now be described in more detail with reference to the drawings. It is shown in:

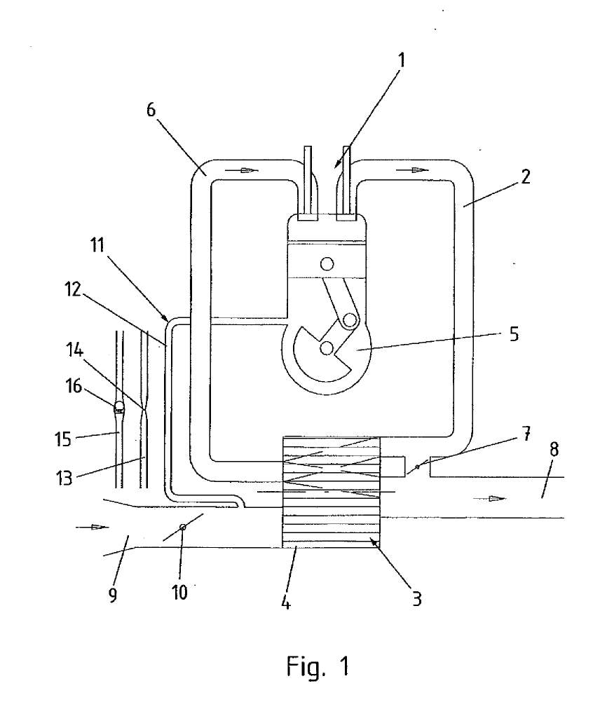

FIG. 1 a schematic view of a combustion engine with associated pressure wave machine;

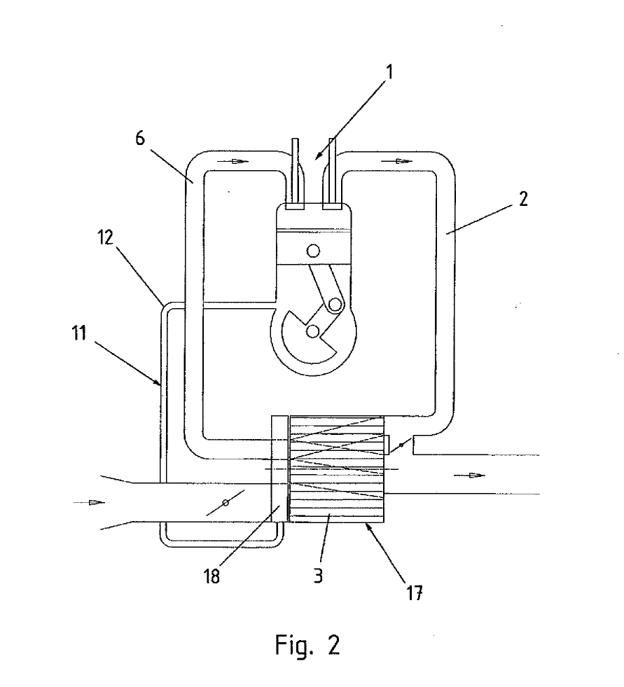

FIG. 2 a modified pressure wave machine with control disk; and

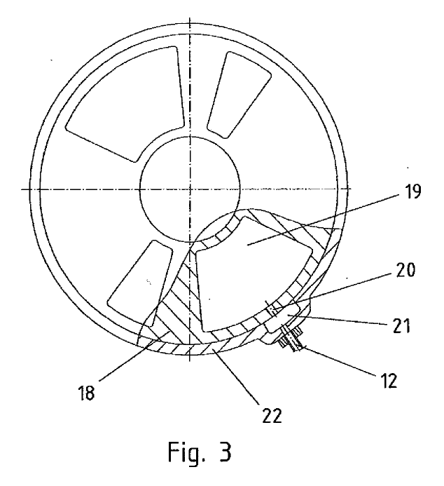

FIG. 3 a detail of the pressure wave charger of FIG. 2.

FIG. 1 shows a combustion engine 1 with a high pressure exhaust gas line 2, which leads to a gas dynamic pressure wave machine 3, of which an exemplary cell rotor 4 is shown here. Exhaust gas under pressure from the combustion engine 1 serves to compress air that is aspirated from the other side of the cell rotor 4 and to feed it into the combustion engine 1. For this, a high pressure charge air line 6 which leads from the gas dynamic pressure wave machine 3 to the combustion engine 4 is provided. Further shown in the exhaust zone is a waste gate 7 which connects the high pressure exhaust line 2 with a low pressure exhaust line 8 as a bypass leading past the gas dynamic pressure wave machine 3. To control the amount of inflowing air, a throttle valve 10 is located in an intake line 9 in the cold gas zone. Further provided is a crankcase ventilation 11 which includes a line 12 which leads from the crankcase 5 of the combustion engine 1 into the intake region of the gas dynamic pressure wave machine 3. Three different lines are illustrated by way of example. While the line 12 has a constant cross section, a throttle 14 in the form of a constriction is provided in line 13. The line 15 has a check valve 16, instead of a throttle. The check valve 16 is configured in such a way that gas from the crankcase 5 of the combustion engine 1 can flow into the intake line 9 or the cell rotor 4, but not from the gas dynamic pressure wave machine 3 back into the crankcase 5. This is achieved through a spring-loaded valve body, here in the form of a sphere.

The embodiment of FIG. 2 differs from the one in FIG. 1 in that the gas dynamic pressure wave machine 17 has a control disk 18 in the intake zone to which line 12 of the crankcase ventilation 11 is connected. For all other remaining components of the shown arrangements, the reference signs introduced in FIG. 1 are used. Further, reference is made to the description in this context.

FIG. 3 shows in detail how the connection of line 12 to the gas dynamic pressure wave machine is realized. The cross sectional view shows that the control disk 18 has openings 19 which extend in an axial direction and via which aspirated air can flow into the spatially following cell rotor. It is further shown that axial opening, labeled 19, has in a border-side web an additional opening 20 which extends in radial direction. The opening 20 leads to a compensating chamber 21 in the cold gas housing 22 for attachment of the line 12. When rotating the control disk 18 in relation to the cold gas housing 22, the opening 20 remains in a position in which the compensating chamber 21 communicates with the opening 19 to thereby ensure a housing ventilation.

### REFERENCE SIGNS

1—Combustion engine
2—High pressure exhaust line
3—Gas dynamic pressure wave machine
4—Cell rotor
5—Crank case
6—High pressure charge air line
7—Waste gate
8—Low pressure exhaust line
9—Intake line
10—Throttle valve
11—Crank case ventilation
12—Line
13—Line
14—Throttle
15—Line
16—Check valve
17—Gas dynamic pressure wave machine
18—Control disk
19—Opening
20—Opening
21—Compensating chamber
22—Cold gas housing

1.-6. (canceled)

7. A gas dynamic pressure wave machine for a combustion engine, said pressure wave machine comprising:
a cold gas housing connected to a crankcase ventilation of the combustion engine;
a cell rotor; and
a control disk positioned at a cold gas side of the pressure wave machine and having an opening, said opening connecting an intake zone of the cell rotor with the crankcase ventilation and extending in a radial direction in relation to a longitudinal axis of the control disk.

8. The gas dynamic pressure wave machine of claim 7, further comprising a throttle integrated in a line of the crankcase ventilation which line leads to the pressure wave machine.

9. The gas dynamic pressure wave machine of claim 7, further comprising a check valve integrated in a line of the crankcase ventilation, which line leads to the pressure wave machine.

10. The gas dynamic pressure wave machine of claim 7, wherein the cold gas housing has a compensating chamber which is connected to a line of the crankcase ventilation and communicates with the intake zone of the cell rotor via the opening in the control disk.

11. The gas dynamic pressure wave machine of claim 10, wherein the control disk is supported for rotation in relation to the cold gas housing to allow adjustment of a fluid communication between the opening of the control disk and the compensating chamber of the cold gas housing.

12. A combustion engine, comprising:
a crankcase ventilation; and
gas dynamic pressure wave machine having a cold gas housing connected to the crankcase ventilation, a cell rotor, and a control disk positioned at a cold gas side of the pressure wave machine and having an opening, said opening connecting an intake zone of the cell rotor with the crankcase ventilation and extending in a radial direction in relation to a longitudinal axis of the control disk.

13. The combustion engine of claim 12, wherein the crankcase ventilation has a line in fluid communication with the pressure wave machine, and a throttle integrated in the line of the crankcase ventilation.

14. The combustion engine of claim 12, wherein the crankcase ventilation has a line in fluid communication with the pressure wave machine, and a check valve integrated in the line of the crankcase ventilation.

15. The combustion engine of claim 12, wherein the crankcase ventilation has a line in fluid communication with the pressure wave machine, said cold gas housing having a compensating chamber which is connected to the line of the crankcase ventilation and communicating with the intake zone of the cell rotor via the opening in the control disk.

16. The combustion engine of claim 15, wherein the control disk is supported for rotation in relation to the cold gas housing to allow adjustment of a fluid communication between the opening of the control disk and the compensating chamber of the cold gas housing.
